(19) United States
(12) Patent Application Publication
(10) Pub. No.: US 2007/0002029 A1
(43) Pub. Date: Jan. 4, 2007

(54) Information processing device and method of controlling vibration of touch panel

(75) Inventor: Kageyuki Iso, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/472,524

(22) Filed: Jun. 22, 2006

(30) Foreign Application Priority Data
Jun. 30, 2005 (JP) 2005-192968

(51) Int. Cl. G09G 5/00

(52) U.S. Cl. 345/173

(57) ABSTRACT

According to one embodiment, an information processing device includes a touch panel, a detecting unit which detects a touched position on the touch panel, a control unit which generates a first drive signal and a second drive signal for vibrating the touched position detected by the detecting unit, a first vibration element provided on an end of the touch panel, and vibrating depending on a first drive signal and a second vibration element provided on an end of the touch panel, and vibrating depending on a second drive signal.

### CROSS-REFERENCE TO RELATED APPLICATIONS

This application is based upon and claims the benefit of priority from Japanese Patent Application No. 2005-192968, filed Jun. 30, 2005, the entire contents of which are incorporated herein by reference.

### BACKGROUND

1. Field

One embodiment of the invention relates to an information processing device having a touch panel, and a method of controlling vibration of a touch panel.

2. Description of the Related Art

Presently, commercially available is an information processing device that has a touch panel attached onto a surface of a display panel and is operable by a user without a keyboard, etc., by touching the surface of the touch panel directly or with a stylus pen.

Japanese Unexamined Patent Publication No. 2002-149312 disclosed a technology of vibrating a tough panel with a vibration element provided on the touch panel in order to allow a user to sense that he/she has operated the touch panel when operating it.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a configuration of a notebook type personal computer as an electronics device and an information processing device according to one embodiment of the present invention;

FIG. 2 is an exemplary block diagram showing a system configuration of the personal computer according to one embodiment of the present invention;

FIG. 3 is an exemplary block diagram showing a configuration for vibrating a touch panel according to one embodiment of the present invention;

FIG. 4 is an exemplary table showing an example of setting stored in a setting table according to one embodiment of the present invention; and

FIG. 5 is an exemplary flow chart showing procedure for vibrating the touch panel according to one embodiment of the present invention.

### DETAILED DESCRIPTION

Various embodiments according to the invention will be described hereinafter with reference to the accompanying drawings. In general, according to one embodiment of the invention, an information processing device includes a touch panel, a detecting unit which detects a touched position on the touch panel, a control unit which generates a first drive signal and a second drive signal for vibrating the touched position detected by the detecting unit, a first vibration element provided on an end of the touch panel, and vibrating depending on a first drive signal and a second vibration element provided on an end of the touch panel, and vibrating depending on a second drive signal.

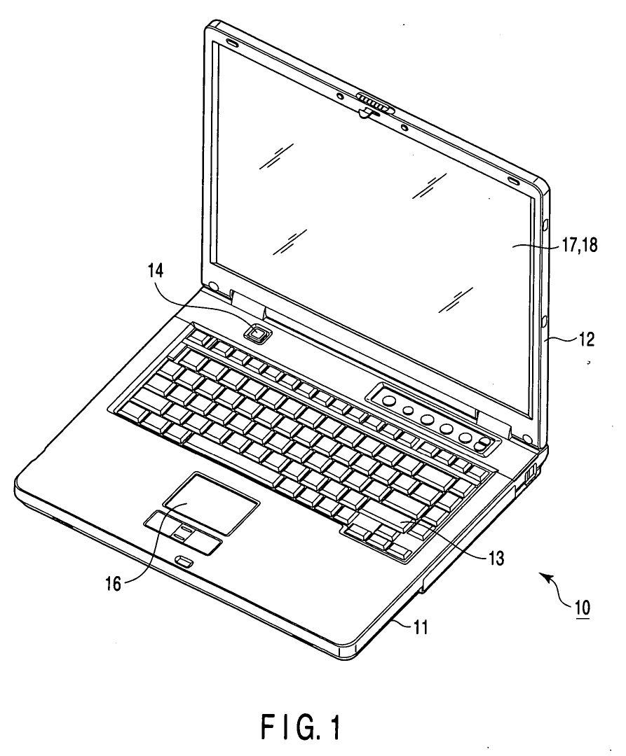

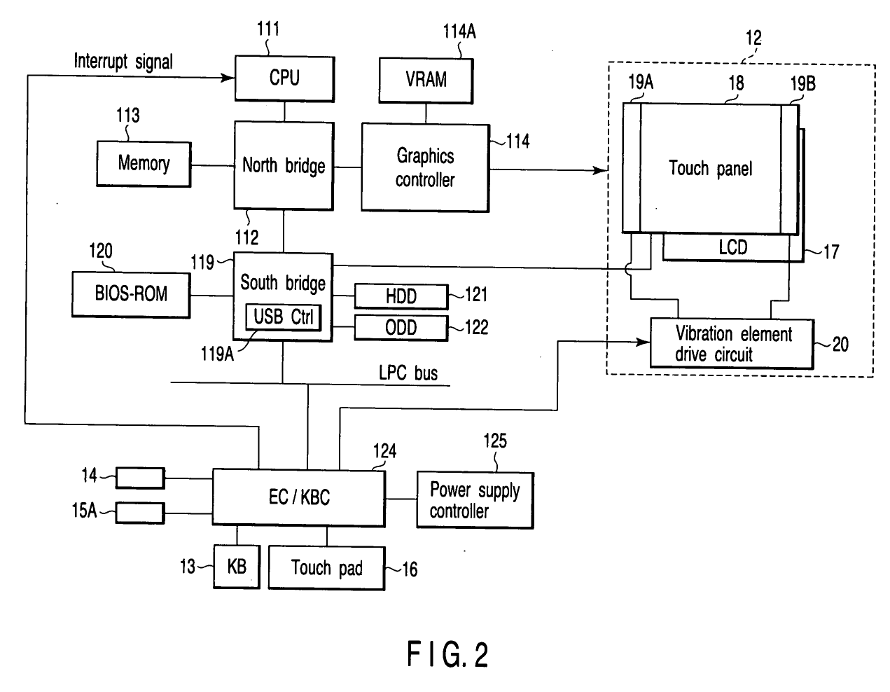

First, referring to FIGS. 1 and 2, explanation will be given to a configuration of an information processing device according to one embodiment of the present invention. The information processing device is embodied as a portable notebook type personal computer 10 that is battery-driven.

FIG. 1 is a perspective view of the notebook type personal computer 10 with a display unit unfolded open. The computer 10 is configured by a computer main body 11 and a display unit 12. A display device comprised of an liquid crystal display (LCD) 17 is assembled in the display unit 12, and a display screen of the LCD 17 is located substantially at the center of the display unit 12. A touch panel 18 is attached onto an image display surface of the LCD 17. Vibration elements are respectively provided on both ends so as to sandwich the touch panel 18 therebetween. Another way of saying,

the touch panel 18 is arranged between two vibration elements.

The display unit 12 is pivotally fixed between an open position and a closed position with respect to the computer main body 11. The computer main body 11 has a slim box-shaped casing on a top face of which are arranged a keyboard 13, a power button 14 for turning ON/OFF the power of the computer 10, a touch pad 18, and the like.

Then, a system configuration of the computer 10 will be explained with reference to FIG. 2.

As shown in FIG. 2, the computer comprises, a CPU 111, a north bridge 112, a main memory 113, a graphics controller 114, a south bridge 119, a BIOS-ROM 120, a hard disk drive 121, an embedded controller/keyboard controller IC 124, and a power supply controller 125, etc.

The CPU 111 is a processor provided to control operation of the computer 10, and executes an operating system and various application programs which are loaded from the hard disk drive 121 to the main memory 113.

In addition, the CPU 111 also executes a BIOS program stored in the BIOS-ROM 120. The BIOS program is a program for control of hardware.

The north bridge 112 is a bridge device which connects between a local bus of the CPU 111 and the south bridge 119. The north bridge 112 also has a built-in memory controller for controlling access to the main memory 113. Further, the north bridge 112 has a function of executing communications with the graphics controller 114 via an AGP bus or the like.

The graphics controller 114 is a display controller for controlling the LCD 17 that is used as a display monitor of the computer 10. The graphics controller 114 has a video memory 114A, and generates picture signals that form a display image to be displayed on the LCD 17 of the display unit 12, from display data written into the video memory 114A by the OS/application program.

The south bridge 119 controls a device on an LPC bus. The south bridge also has a built-in IDE controller for controlling the HDD 121. Furthermore, the south bridge 119 also has a function of controlling access to the BIOS-ROM 120. In addition, the south bridge 119 further has a universal serial bus (USB) controller 119A for controlling data transmission with any device that supports the USB standard.

The touch panel 18 which is a device that supports USB standard executes data transmission with the USB controller 119-A contained in the south bridge 119.

The embedded controller/keyboard controller IC 124 is a one-chip microcomputer in which an embedded controller for power management and a keyboard controller for controlling the keyboard 13 and the touch pad 18 are integrated. The embedded controller/keyboard controller IC 124 has a function of, by operating in cooperation with the power supply controller 125, turning the power ON/OFF of the computer 10 depending on manipulation of the power button 14 by the user.

The vibration element drive circuit 20 is a circuit for driving a first vibration element 19A and a second vibration element 19B. The EC/KBC 124 supplies a control signal to the vibration element drive circuit 20 such that there occurs a phase difference between a wave generated at the touch panel 18 from vibration of the first vibration element 19A and a wave generated at the touch panel 18 from vibration of the second vibration element 19B. The phase difference between the two waves results in interference when the two waves overlap, thus generating a part with strong vibration and a part with weak vibration.

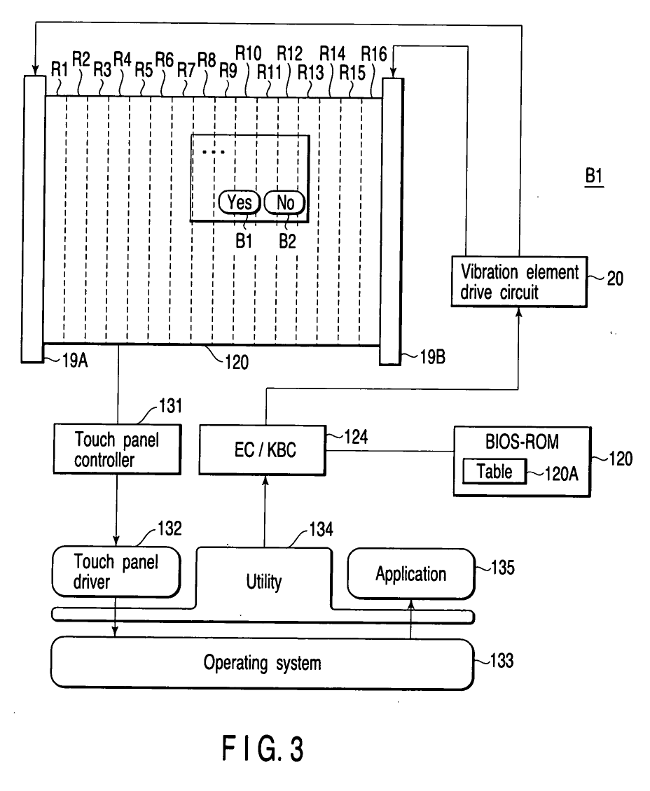

Now, with reference to FIG. 3, explanation will be given to a configuration for vibrating a predetermined region of the touch panel 18.

When the user operates by touching the surface of the touch panel 18 with his/her finger or a stylus pen, a touch panel controller 131 supplies coordinate data of a touched position to a touch panel driver 132.

The touch panel driver 132 supplies the coordinate data to an operating system 133. In the case where the coordinate data corresponds to an area of a button that is an operating unit, the operating system 133 outputs an event signal to an application 135.

A utility 134 hooks the position coordinate data outputted from the touch panel controller and the event signal outputted from the operating system 133.

The utility 134 notifies the EC/KBC 124 of the coordinate data of the operated position. The EC/KBC 124 accesses a setting table 120A that is storage in the BIOS-ROM 120 and reads setting of a control signal to be supplied to the vibration element drive circuit 20. Note that the setting table 120A may be stored in the EC/KBC 124.

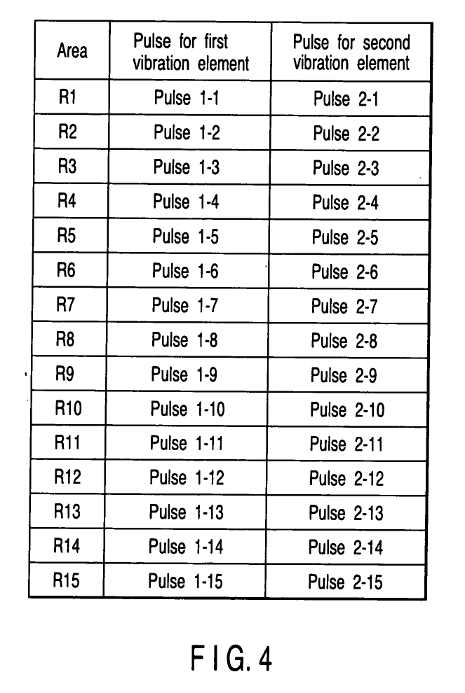

The surface of the touch panel 18 is divided into a plurality of, i.e., 16 areas in the horizontal direction. In the BIOS-ROM 120 is stored the setting by which any one of areas R1 to R16 is strongly vibrated by vibrating the two vibration elements 19A, 19B. FIG. 4 shows an example of the setting. As shown in FIG. 4, a control signal for giving a pulse wave to the first vibration element 19A and the second vibration element 19B is supplied from the EC/KBC 124 to the vibration element drive circuit 20.

Depending on the control signal, the vibration element drive circuit 20 supplies a first drive voltage to the first vibration element 19A and a second drive voltage to the second vibration element 19B, whereby any of the touch panel areas R1 to R16 is strongly vibrated.

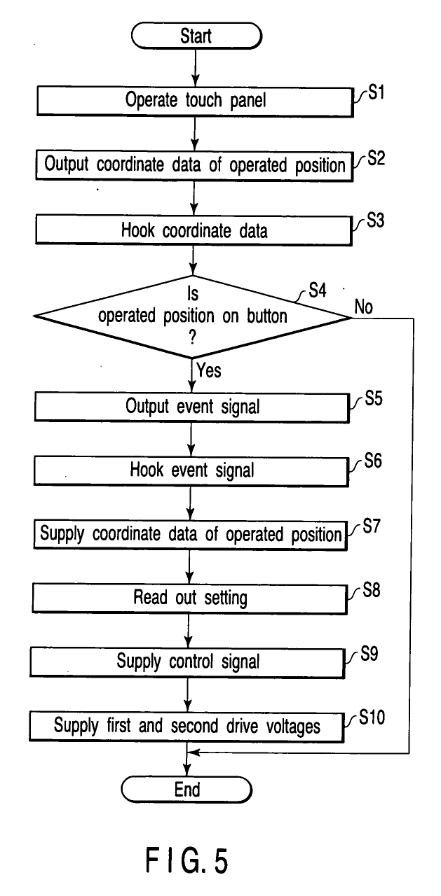

In the following, the process for vibrating the touch panel 18 will be explained with reference to a flow chart of FIG. 5.

When the user manipulates the touch panel 18 (block S1), the touch panel controller 131 supplies coordinate data of a touched position to the touch panel driver 132 (block S2).

The utility 134 hooks the coordinate data of the touched position supplied from the touch panel driver 132 to the operating system 133, and delivers the coordinate data to the operating system 133 (block S3).

The operating system 133 determines whether or not the coordinate data of the touched position corresponds to the button B1 or button B2 that is the operating unit (block 4). When the touched position does not correspond to the button B1 or B2 (NO in block S4), the process is terminated.

If the touched position is on the button B1 or B2 (YES in block S4), the operating system 133 supplies an event signal that notifies the application 135 that any one of the buttons B1 or B2 has been manipulated (block S5).

The utility 134 hooks the event signal to be supplied to the application 135, and supplies it to the application 135 (block S6).

After notifying the EC/KBC 124 of an interrupt, the utility 134 supplies the coordinate data of the touched position to the EC/KBC 124 (block S7). The EC/KBC 124 calls setting corresponding to the supplied coordinate data from the setting table 120A (block S8).

The EC/KBC 124 supplies a control signal to the vibration element drive circuit 20 depending on the setting that has been read out (Step S9). Depending on the supplied control signal, the vibration element drive circuit 20 supplies the first drive voltage to the first vibration element 19A and the second drive voltage to the second vibration element 19B (block S10).

A predetermined phase difference is made to occur between the wave at the touch panel 18 resulting from vibration of the first vibration element 19A and the wave at the touch panel 18 resulting from vibration of the second vibration element 19B and then interfered, a portion that vibrates strongly and a portion that vibrates weakly are brought about. Consequently, this allows the user to easily sense the operation he/she has done.

Note that, although the touch panel is designed to vibrate when the user manipulates the button, the touch panel may be such designed that a manipulated portion thereof vibrates even though the user operates any other area than the button.

When the user manipulates the touch panel, the operator may be given feedback on the input operation by applying to an icon or a point touched on the operation surface a control by which a resonance point of vibration is aligned/an offset point is aligned/no vibration is given, etc depending on the input operation.

Although two vibration elements are used in the embodiment, three or more vibration elements may be used. In the case of the two vibration elements, a portion to be vibrated is shaped like a belt. If three or more vibration elements are used, however, pinpoint vibration can be provided. Although the first vibration element and the second vibration element are arranged such that the touch panel is sandwiched therebetween in the embodiment described above, the first and second vibration elements may alternatively be provided on a pair of ends being connected at the corner of the touch panel. Even such an arrangement allows a specific portion to be strongly vibrated by causing interference due to overlapping of the wave formed by the first vibration element and the wave formed by the second vibration element.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a touch panel;
a detecting unit which detects a touched position on the touch panel;
a control unit which generates a first drive signal and a second drive signal for vibrating the touched position detected by the detecting unit;
a first vibration element provided on an end of the touch panel, and vibrating depending on a first drive signal; and
a second vibration element provided on an end of the touch panel, and vibrating depending on a second drive signal.

2. The information processing device according to claim 1, wherein the touch panel is arranged between the first vibration element and the second vibration element.

3. The information processing device according to claim 1, wherein the touch panel includes a plurality of areas, the information processing device further comprises a storage which stores settings of the first drive signal and the second drive for every area.

4. The information processing device according to claim 3, wherein
the touch panel is arranged between the first vibration element and the second vibration element, and
the plurality of areas are provided in a direction from the first vibration element to the second vibration element.

5. The information processing device according to claim 1, further comprising:
a display panel configured to display an operating button and which overlap with the touch panel; and
a determination unit which determines whether or not the touched position is on the operating unit,
wherein, the control unit generates the first drive signal and the second drive signal when the determination unit determines that the touched position is on the operating unit.

6. A method of controlling vibration of a touch panel in an information processing device having the touch panel, a first vibration element provided on an end of the touch panel, and a second vibration element provided on an end of the touch panel, the method comprising:
detecting a touched position on the touch panel; and
vibrating the first vibration element and the second vibration element for vibrating the detected touched position.

7. The method of controlling vibration of a touch panel, according to claim 6, further comprising:
setting a first and a second drive signals depending on the touched position; and
supplying the first drive signal to the first vibration element, and the second drive signal to the second vibration element.

8. The method of controlling vibration of a touch panel, according to claim 7, wherein
the touch panel including a plurality of areas, and the information processing device further includes a storage storing settings of the first drive signal and the second drive signal for every area,
the method further including:
reading the settings of the first and second drive signal which correspond to the area including the detected touched position from the storage.

9. The method of controlling vibration of a touch panel, according to claim 8, wherein
the touch panel is arranged between the first vibration element and the second vibration element, and
the plurality of areas are provided in a direction from the first vibration element to the second vibration element.

10. The method of controlling vibration of a touch panel, according to claim 6, wherein the information processing device further comprises a display panel configured to display an operating button and which overlap with the touch panel, the method further including:
determining whether or not the touched position is on the operating unit; and
vibrating the touched position when it is determined that the touched position is on the operating unit.
